(19) United States
(12) Patent Application Publication
(10) Pub. No.: US 2004/0265451 A1
(43) Pub. Date: Dec. 30, 2004

(54) Method and system for micro-particulating food matter

(76) Inventors: Michael A. Rooks, Hamden, CT (US); Marilyn A. Estlick, Monroe, CT (US); Lori L. Lathrop Stern, Oxford, CT (US); Anthony M. Gray, Huntington, CT (US); Andrew G. H. Lea, Abingdon (GB)

Correspondence Address: BAKER BOTTS L.L.P., 2001 ROSS AVENUE, SUITE 600, DALLAS, TX, 75201-2980, US

(21) Appl. No.: 10/875,468

(22) Filed: Jun. 23, 2004

Related U.S. Application Data
(60) Provisional application No. 60/482,485, filed on Jun. 24, 2003.

(51) Int. Cl. C12H 1/10

(52) U.S. Cl. 426/489

(57) ABSTRACT

According to one embodiment of the invention, a method for food processing is provided. The method includes freezing at least a portion of a piece of fruit to produce frozen material. The method also includes grinding the frozen material into a plurality of particles. A majority of the particles have a size less than 750 microns.

### RELATED APPLICATIONS

This application claims the benefit under 35 U.S.C. § 119(e) of U.S. Provisional Application Ser. No. 60/482,485, entitled “Applesauce Containing Ground Apple Peel and Method,” filed on Jun. 24, 2004.

### TECHNICAL FIELD OF THE INVENTION

This invention relates generally to food production and more particularly to a method and system for producing food comprising ground fruit and/or vegetable.

### BACKGROUND OF THE INVENTION

Certain food items, such as fruits and vegetables, contain substantial amounts of vitamins and other nutrients. Different parts of a fruit or vegetable may include different types and amounts of nutrients. For example, an apple's flesh generally has different amounts of nutrients than its peel. Although the flesh of the apple is the portion that is generally consumed, a significant amount of phytochemicals, antioxidants, vitamins, fiber, and other nutrients may also be in the peel of the apple. However, food manufacturers generally discard peels and other unused portions of fruits and vegetables or use them for non-nutritional purposes.

### SUMMARY OF THE INVENTION

According to one embodiment of the invention, a method for food processing is provided. The method includes freezing at least a portion of a piece of fruit to produce frozen material. The method also includes grinding the frozen material into a plurality of particles. A majority of the particles have a size less than 750 microns.

The invention has several important technical advantages. Embodiments of the invention may have some, none, or all of these advantages. The efficiency of raw food usage may be improved by using the invention to transform generally discarded portions of raw food into powdered food with substantial vitamins and/or other nutrients. The nutritional level of food prepared using fruits and vegetables may be increased by using the invention. Taste and culinary appeal of food may be improved by using a nutritional additive produced in accordance with the invention using generally discarded and/or unpalatable portions of food items, such as the peel (or other frequently discarded portion) of fruits and vegetables. Other advantages may be readily ascertainable by those skilled in the art.

### BRIEF DESCRIPTION OF THE DRAWINGS

Reference is now made to the following description taken in conjunction with the accompanying drawings, wherein like reference numbers represent like parts, in which:

FIG. 1 is a block diagram illustrating one embodiment of a food product manufacturing system constructed in accordance with the present invention;

FIG. 2 is a schematic diagram illustrating one embodiment of a low temperature food processing system; and

FIG. 3 is a flowchart illustrating one embodiment of a method of producing a powdered food item produced by grinding a larger food item.

### DETAILED DESCRIPTION OF THE INVENTION

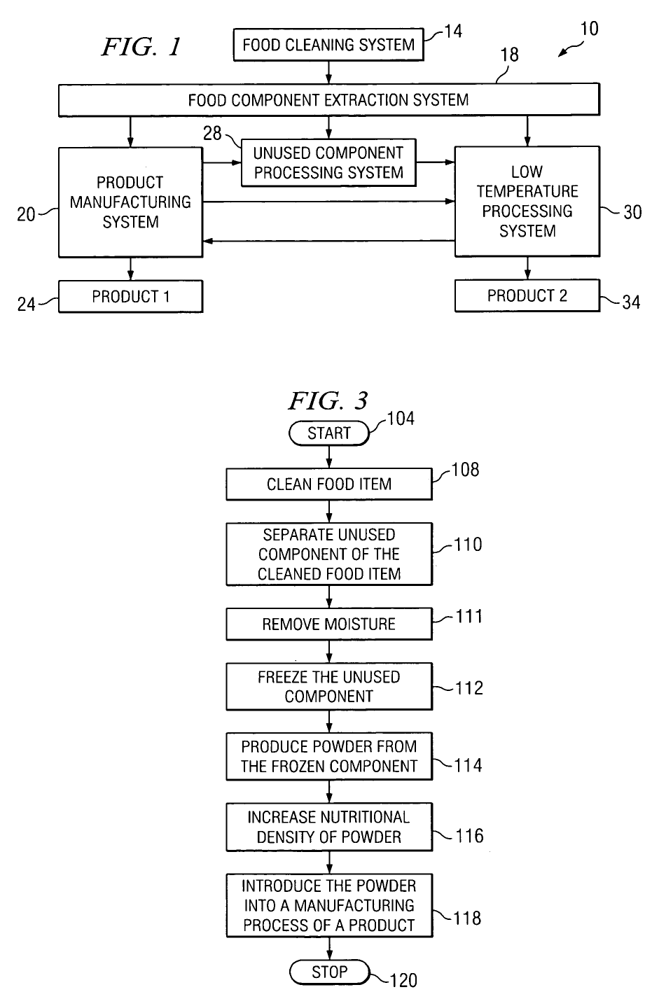

The invention is best understood by referring to FIGS. 1 through 3 of the drawings, like numerals being used for like and corresponding parts of the various drawings.

FIG. 1 is a block diagram illustrating one embodiment of a food manufacturing system 10 constructed in accordance with the teachings of the present invention. System 10 comprises a food cleaning system 14, a food component extraction system 18, a product manufacturing system 20, and an unused component processing system 28. Food cleaning system 14 may be coupled to food component extraction system 18. Food component extraction system 18 may coupled to both product manufacturing system 20 and unused component processing system 28. Any delivery system (not explicitly shown in FIG. 1), such as a conveyor system, may be used to couple systems 14, 18, 20, and 28; however, where systems 14, 18, 20, and 28 are not physically coupled, the food processed in one of the systems may be delivered to the next system using any suitable system or method. For example, the processed food from one system may be delivered to the next system manually. In describing system 10 and any other method or system herein, an apple is used as an exemplary food item; however, fruits, vegetables, or any other suitable food item may also benefit from the teachings of the present invention.

Food cleaning system 14 is operable to clean apples by removing or neutralizing dirt, pesticides, fertilizer, or any other undesirable substance that may be attached to apples. For example, apples may be mechanically or manually washed with water and/or any suitable cleaning agent. In some instances, antibacterial liquids or other germ-killing substances may also be applied to the apples using system 14. Food component extraction system 18 is operable to mechanically and/or manually separate the undesired components of an apple from the desired components. The terms “desired” and “undesired” are meant to refer to what is desirable in the context of making a particular product. In some applesauce making processes, the peel is undesirable so it is removed and discarded. In other processes, an apple may be peeled and de-cored (removal of the core of the apple), by food component extraction system 18. Product manufacturing system 20 is operable to receive the desired portion of the apple, such as the flesh of the apple, and mechanically and/or manually process the received portion to produce a product 24, such as apple juice or applesauce. While the invention may be used to reduce waste by making use of the “undesirable” discarded portions of a fruit, vegetable, or other food product, the invention could be used to grind entire fruits, vegetables, or other food products without departing from the scope of the invention. The invention may also be used to grind a combination of “undesirable” and “desirable” portion of food products.

Depending on the desired end product, systems 14, 18, and 20 may be configured differently. For example, where the desired end product is applesauce, component extraction system 18 may be configured to remove the core of the apple. Where applesauce having a smoother texture is desired, the peel may also be removed. Product manufacturing system 20 may be configured to receive the desired portion of the apple from system 18, and cook and/or crush them to produce applesauce. However, where the desired end product is apple juice, component extraction system 18 may be configured to remove the core of the apple but leave the peel. Alternatively, both the core and peel could be removed. Also, the peel could be removed and the core left in place. Manufacturing system 20 may be configured to squeeze the desired portion of the apple to produce apple juice and the remaining apple solids from the squeezing process. Other configurations may be adopted for systems 14, 18, and 20 for producing other products. In some cases food cleaning system 14 and food component extraction system 18 may be omitted or placed at different stages within the system.

Unused component processing system 28 may be configured to receive any “undesired” portion of apples from component extraction system 18 and/or product manufacturing system 20 and either discard it or process it to produce a different product.

Here, the invention can be used to process discarded portions of fruits and/or vegetables to create various nutritional additives that may be used in a variety of other food products. Again, a whole fruit or vegetable could also be used to create these nutritional additives without departing from the scope of the invention. In general, the overall usage of raw food can be increased and waste reduced by using generally discarded portions of raw food to create powdered nutritional additives. The nutritional additives may be used to increase the nutritional level of food incorporating them. Some additives prepared with the invention may improve taste, nutritional value, texture, and/or aesthetic appeal of the food to which they are added. Nutritional additives are created according to the invention by freezing and grinding whole or parts of fruits, vegetables or other foods.

Referring back to FIG. 1, a low temperature processing system 30 may be coupled to unused component processing system 28, food component extraction system 18, and/or product manufacturing system 20. Low temperature processing system 30 may receive desirable portions and/or undesirable portions of a food product from systems 18, 20, and/or 28. Low temperature processing system 30 may be used to freeze the received food components (or whole fruits/vegetables etc.) and grind them into particles having a desired size. In one embodiment, a cryogenic freezing and grinding technique may be used to freeze and grind the food. For example, pomace of apple may be received, cryogenically frozen, and ground into particles on the order of 750 microns or smaller. In another example, peel of apple may be received, cryogenically frozen, and ground into particles on the order of 750 microns or smaller. The powder form of the product provides various options with respect to mouth feel, texture, taste, etc., when adding the powder to other foods.

In one embodiment, moisture may be removed from the food product in conjunction with the cryogenic freezing and grinding. For example, more than thirty five percent of the weight of apple peel may be reduced by moisture extraction. In one embodiment, moisture removal may improve the efficiency of cryogenic freezing and grinding. It is believed that cryogenic grinding preserves nutritional value, such as the phytochemicals in apple peel, while allowing the food to be ground into a fine powder. A food product produced from cryogenic grinding according to the teachings of the present invention may have higher levels of phytochemicals than those in food products produced from conventional processes.

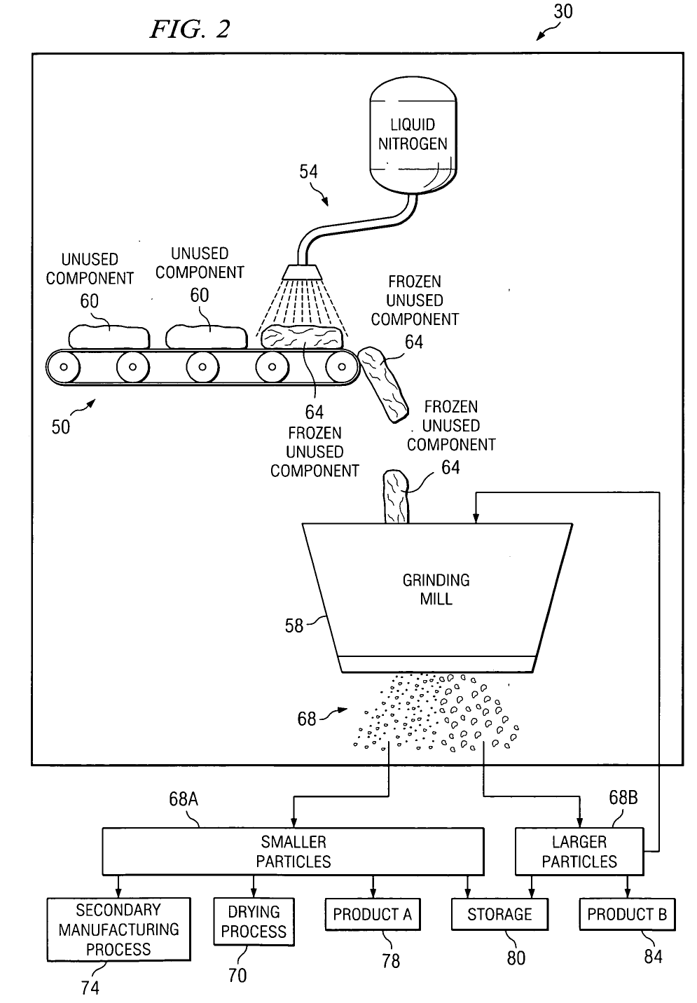

FIG. 2 is a schematic diagram illustrating one embodiment of a low temperature processing system 30. In this embodiment, system 30 comprises a conveyor belt system 50, a freezing agent delivery system 54, and a grinding mill 58. In one embodiment, conveyer belt system 50 is operable to carry unused components 60 of apple so that the temperature of unused components 60 may be lowered using a freezing agent provided by system 54 to produce frozen components 64. Again, while “unused components” of a food item typically refers to a portion of a food item typically discarded during the manufacturing of a food product, the invention could be used with whole fruits, vegetables, or other foods not discarded from another manufacturing process, in which case whole (or parts of) fruits, vegetables, or other foods could be substituted for unused component 60.

Conveyer belt system 54 is also operable to deliver frozen components 64 to grinding mill 58. A different conveyor system could be used for this purpose or any other method of transporting unused components 60 or frozen unused components 64 without departing from the scope of the invention. Freezing agent delivery system 54 is operable to deliver a freezing agent, such as liquid nitrogen, to unused component 60 to freeze and embrittle unused component 60. Grinding mill 58 is operable to grind any embrittled food component, such as frozen component 64, into particles 68 having a desired size. Examples of grinding mill 58 include, but are not limited to, a rotary mill, hammer mill, a ball mill, a bead mill, and a pin mill. In one embodiment, grinding mill 58 is operable to reduce frozen component 64 into particles 68 each having a size no greater than 750 microns. In another embodiment, the particle size is between 60 microns to 300 microns; however, any other particle sizes may be produced depending on the anticipated use of particles 68. For example, any of the following sizes might be used:

a) substantially all (or a majority of) particles smaller than 600 microns;

b) substantially all (or a majority of) particles smaller than 500 microns;

c) substantially all (or a majority of) particles smaller than 400 microns;

d) substantially all (or a majority of) particles smaller than 300 microns;

e) substantially all (or a majority of) particles smaller than 200 microns;

f) substantially all (or a majority of) particles smaller than 100 microns;

g) substantially all (or a majority of) particles smaller than 50 microns.

The particle size of powder 68 produced from grinding mill 58 may vary depending on the intended application of powder 68. For example, larger particles may be used in applications where texture is not a critical factor. For example, if powder 68 is to be added to cereal bars, the particle size may be larger (e.g. greater than 300 microns). However, if powder 68 is being added to applesauce, the particle size may need to be small in order to provide a smooth texture (e.g. less than 300 microns).

In one embodiment, a screen may be used in conjunction with grinding mill 58 to separate small particles 68A from large particles 68B. Small particles 68A may undergo a drying process 70, a secondary manufacturing process 74, such as being added to applesauce, or may be turned into a separate product 78. Examples of product 78 include a capsule containing small particles 68A that may be consumed as a nutritional supplement or a drink mix. Small particles 68A may also be stored in a storage facility 80 for later use.

Examples of drying process 70 include freeze drying, vacuum drying, spray drying, and convective drying. In one embodiment, drying process 70 is used to reduce the water activity level of particles 68A and/or 68B to less than 0.62. In one embodiment, the water activity may be reduced to a range between approximately 0.2 to 0.4. In one embodiment where unused component 60 comprises apple peel, water activity is reduced to less than 0.4. Water activity in food refers to a ratio between the vapor pressure of the food when in a completely undisturbed balance with the surrounding air media and the vapor pressure of distilled water under similar conditions. For example, a water activity of 0.40 means the vapor pressure is 40 percent of that of pure water. The water activity increases with temperature. The moisture condition of a product can be measured as the equilibrium relative humidity (ERH) expressed in percentage or as the water activity expressed as a decimal. Most foods have a water activity above 0.95. Such a level will provide sufficient moisture to support the growth of bacteria, yeast, and mold. The amount of available moisture can be reduced to a point which will inhibit the growth of the organisms.

Large particles 68B may be turned into a separate product 84, such as a cereal flavoring agent or a nutritional agent. Larger particles 68B may also be recycled back to grinding mill 58 so that they can be reduced to small particles 68A. Where larger particles 68B are desired, large particles 68B may also undergo processes 70 and 74. While this embodiment separates particles into two size ranges, particles could be separated into two or more size ranges where desired for particular applications. Separation into multiple sizes could also be omitted.

Although conveyor belt system 50, freezing agent delivery system 54, and grinding mill 58 are shown in FIG. 2 as components to move, freeze, and grind an unused food component, any other mechanical, electrical, chemical, or other means operable to perform functions analogous to those of conveyor belt system 50, freezing agent delivery system 54, and grinding mill 58 may be used in some embodiments of the invention. For example, unused component 60 may be manually delivered to grinding mill 58 from system 54. Unused component 60 may be frozen using any suitable refrigeration technique, including exposure to liquid nitrogen, liquid CO₂, or convective refrigeration using refrigeration coils. In one embodiment, the refrigeration technique is capable of freezing unused component 60 into a point of embrittlement. In one embodiment, the refrigeration technique is capable of freezing unused component 60 at a temperature lower than −300° F. For example, in one embodiment, exposure to liquid nitrogen having a temperature of approximately −320° F. is used as a suitable refrigeration technique. Frozen component 64 may be ground using a grinder, chopper, or any other suitable pulverizing means to produce the desired particle size. In one embodiment, the freezing and/or grinding is performed in an inert environment. Providing an inert environment (using inert gases, for example) may mitigate the effects of oxidation due to heat exposure and/or exposure to oxygen, in one embodiment.

In addition to the options discussed, the unused component 60 or frozen unused component 64 could be cleaned and/or otherwise treated with ascorbic acid or preservatives during the process. Also, dried particles could be used in a secondary manufacturing process 74, or to make product A 78 or product B 84. Larger particles 68B could also be freeze dried and then used in other products.

FIG. 3 is a flowchart illustrating one embodiment of a method 100 for producing a nutritional additive. Method 100 starts at step 104. At step 108, a food item (or a portion thereof), such as apples, is cleaned. Examples of such cleaning may include washing, removal and/or neutralization of undesired dirt, microorganisms and/or chemicals. In one embodiment, apples (or parts thereof) may be cleaned and/or treated to reduce living organisms present on the apple. At step 110, certain components of the apple may be separated from the flesh of the apple. For example, apple may be peeled, seeded, de-cored, and/or squeezed. In another example, the leftover component from squeezing the juice out of apple components may constitute an unused component of step 110. At step 111, the moisture level of the unused component may be reduced. Step 111 may not be need for components remaining from producing apple juice. However, where unsqueezed components are used, step 111 may be used to reduce the moisture level of the component to increase the efficiency of subsequent power production process. In one embodiment, approximately 35 percent or more of the juice is removed from the unused components; however, any suitable percentage of juice may be removed from the unused components. Each of steps 108, 110, and 111 may be omitted or performed at other times (or in a different order) without departing from the scope of the invention.

At step 112, any unused component of the apple, such as the peel, seed, core, pomace, flesh, or stem, may be frozen, or the whole apple may be frozen. A cryogenic freezing process may be used for this purpose. The freezing step of step 112 may be timed, relative to prior processing of the food item, so that a desired nutritional level of a component of a food item may be preserved. The timing may vary depending on the particular rate of nutrition degradation associated with a particular component of a particular food item. For example, if the level of antioxidants found in a particular component of a food item is determined to decrease by 10% every hour after the removal of the particular component from the food item, and at least 50 percent of the maximum nutritional density is desired in the resulting powder, the particular component of the food item may be frozen within 5 hours from when the component is removed from the food item. “Maximum nutritional density” of a particular component of a food item refers to the level of nutrition available per unit of the component prior to the cleaning of the food item at step 108.

At step 114, powder is produced from the frozen components of the food item. A grinding mill, such as grinding mill 58, may be used to produce powder having a desired particle size. The particle sizes discussed above may be used. At step 116, the nutritional density of the powder may be increased using any suitable method. For example, water may be removed from the powder by freeze drying the powder. In one embodiment, water activity level may be reduced to 0.62. The level of water activity may also be reduced to approximately between 0.2-0.4. Step 116 may be omitted or performed before step 114. At step 118, the produced powder is introduced into a manufacturing process of a food product. The method stops at step 120. The powder produced at step 114 could also be cleaned or otherwise processed before or after step 116 or prior to step 118 (if step 116 is omitted).

Preservatives may be added to the food component at steps 110, 112, 114, or 116 to enhance the preservation of nutrition and/or appearance. The appearance of degradation associated with time may be lessened by the cryogenic freezing process, but not all food items may attain this benefit from such freezing.

The powder produced as discussed above may have a variety of applications. For example, the powder may be added to applesauce, food purees, beverages such as smoothies, fruit snacks, fruit fillings, cereals, cereal bars, baked goods, gummies, chewy candies, frozen fruit snacks, salad dressing, sauces, yogurt and dairy products, jello, puddings, and used as natural coloring. The powder may also be used as a breath-freshening agent for confections, gums, instant drink powder, a bulking agent, a source of fiber, a nutritional supplement, or a vitamin supplement. The powder may also be used for products that are not orally consumed. For example, the powder may be used as cosmetics, scrubs, and skin masks. The powder may also be used to decorate food, such as toppings, sprinkles, color, texture, and nutrients. Many other possible applications exist. In one embodiment, a sweetener is added to a product in conjunction with the produced powder. An example of sweetener includes high fructose syrup, corn syrup, sucrose syrup, and powder sucrose. However, any suitable sweetener or a combination of suitable sweeteners may be used. This is advantageous in some embodiments because adding sweetener improves the preservation of the color of the food product. For example, when high fructose syrup is added to applesauce, the natural color of applesauce may be preserved for a longer period of time.

Although apple peel is used as an example of unused component of a fruit, other components of other fruits or vegetables may also be used. Examples include peach skin, pear skin, plum skin, cranberry peel, mango skin, hues extracted from aloe vera plant, bean and pea pods, carrot skin, grape peel, nectarine peel, citrus peel, or any other component having a desired quality. Again, as noted above, the whole fruit or vegetable could be ground into powder form in accordance with the process described above without departing from the scope of the invention.

Although some embodiments of the present invention have been described in detail, it should be understood that various changes, substitutions, and alterations can be made hereto without departing from the spirit and scope of the invention as defined by the appended claims.

What is claimed is:

1. A method for food processing, comprising:
removing juice from at least a portion of a piece of fruit;
after removing the juice, cryogenically freezing the portion of a piece of fruit by exposing the portion of the piece of fruit to liquid nitrogen, the cryogenically frozen portion of the piece of fruit having a temperature of minus 300 degrees Fahrenheit or lower; and
grinding the cryogenically frozen portion of the piece of fruit into a plurality of particles in an inert environment, wherein a majority of the particles has a size less than 750 microns.

2. The method of claim 1, and further comprising reducing a level of water activity in the particles to below approximately 0.62

3. The method of claim 1, wherein the portion of the piece of fruit comprises apple peel.

4. The method of claim 1, and further comprising adding the particles into a food product after reducing the level of water activity and freeze drying.

5. A method for food processing, comprising:
freezing at least a portion of a piece of fruit to produce frozen material; and
grinding the frozen material into a plurality of particles wherein a majority of the particles have a size less than 750 microns.

6. The method of claim 5, wherein the at least a portion of the piece of fruit comprises the entire piece of fruit.

7. The method of claim 5, wherein the portion of the piece of fruit comprises the peel of the fruit.

8. The method of claim 5, wherein the fruit is an apple.

9. The method of claim 5, wherein freezing comprises cryogenically freezing the at least a portion of the piece of fruit using liquid nitrogen.

10. The method of claim 5, wherein a majority of the particles have a size less than 300 microns.

11. The method of claim 5, and further comprising freeze drying at least some of the plurality of particles.

12. The method of claim 5, wherein grinding the frozen material comprises grinding the frozen material while exposing the frozen material to an inert gas.

13. The method of claim 5, and further comprising reducing a level of water activity in at least some of the particles to below approximately 0.62.

14. The method of claim 5, and further comprising reducing a level of water activity in at least some of the particles to approximately between 0.2 to 0.4.

15. The method of claim 5, wherein freezing comprises freezing at least a portion of a piece of fruit to produce frozen material having a temperature of approximately minus 300 degrees Fahrenheit or lower.

16. The method of claim 5, wherein freezing comprises freezing at least a portion of a piece of fruit to produce frozen material having a temperature lower than 32 degrees Fahrenheit.

17. The method of claim 5, and further comprising:
separating at least some of the particles that are larger than a predetermined particle size; and
regrinding the separated particles.

18. The method of claim 5, wherein grinding comprises grinding using a rotary grind mill.

19. The method of claim 5, wherein the portion of the piece of fruit comprises an initial level of nutritional value, and further comprising:
extracting liquid from the portion of the piece of fruit; and
wherein freezing comprises freezing the at least a portion of a piece of fruit no later than 30 minutes after extracting the liquid, thereby slowing a reduction rate of the initial level of nutritional value of the portion of the piece of fruit.

20. The method of claim 5, wherein freezing comprises freezing at least a portion of a piece of fruit to produce frozen material that is brittle.

21. The method of claim 5, wherein freezing comprises freezing at least a portion of a piece of fruit to produce frozen material by providing a flow of liquid nitrogen over the portion of the piece of fruit.

22. The method of claim 5, and further comprising:
adding the particles into a food product; and
adding high fructose or sucrose into the food product.

23. The method of claim 5, and further comprising:
adding the particles into a food product; and
adding a sweetener into the food product.

24. The method of claim 5, wherein a majority of the particles have a size of less than 50 microns.

25. A food composition comprising:
applesauce, wherein the applesauce comprises a plurality of particles that were produced by grinding frozen apple peel prior to being added to the applesauce, and wherein the particles may or may not be frozen when being added to the applesauce.

26. The food composition of claim 25, wherein a majority of the particles have a size of less than 750 microns.

27. The food composition of claim 25, wherein a majority of the particles have a size of less than 300 microns.

28. The food composition of claim 25, wherein a majority of the particles have a size of less than 70 microns.

29. The food composition of claim 25, wherein the particles, prior to being added to the applesauce, have a level of water activity below approximately 0.62.

30. The food composition of claim 25, wherein the particles, prior to being added to the applesauce, have a level of water activity between approximately 0.2 to 0.4.

31. The food composition of claim 25, wherein the frozen apple peel comprises cryogenically frozen apple peel.

32. The food composition of claim 25, wherein the plurality of particles are produced by grinding cryogenically frozen apple peel cryogenically frozen no later than 30 minutes after juice is extracted from the apple peel.

33. The food composition of claim 25, wherein the plurality of particles were produced by grinding the frozen apple peel in an inert atmosphere.

34. A nutritional additive comprising:
a plurality of particles produced at least by cryogenically freezing at least a portion of a piece of fruit, wherein a majority of the particles has a size of less than 750 microns.

35. The nutritional additive of claim 34, wherein the at least a portion of a piece of fruit comprises apple peel.

36. The nutritional additive of claim 34, wherein a majority of the particles has a size less than 300 microns.

37. The nutritional additive of claim 34, wherein a majority of the particles comprises substantially all of the particles having a size less than 300 microns.

38. The nutritional additive of claim 34, wherein the particles are freeze dried.

39. The nutritional additive of claim 34, wherein the particles are vacuum dried.

40. The nutritional additive of claim 34, wherein a majority of the particles have a level of water activity below approximately 0.62.

41. The nutritional additive of claim 34, wherein the plurality of particles is produced at least by cryogenically freezing at least a portion of a piece of fruit using a medium having a temperature of approximately minus 300 degrees Fahrenheit or lower.

42. The nutritional additive of claim 34, wherein the particles are produced at least by grinding, in an inert atmosphere, the cryogenically frozen portion of a piece of fruit.

43. The nutritional additive of claim 34, wherein the plurality of particles is produced at least by extracting liquid from the portion of the piece of fruit, cryogenically freezing the portion of the piece of fruit no later than 30 minutes after the act of extracting liquid, and grinding the cryogenically frozen portion of the piece of fruit.

44. A method for processing food, comprising:
freezing to the point of embrittlement at least a portion of a food item; and
grinding the embrittled portion of the food item into a plurality of particles.

45. The method of claim 44, wherein freezing to the point of embrittlement comprises exposing the portion of the food item to liquid nitrogen at a temperature of minus 300 degrees Fahrenheit or lower.

46. The method of claim 44, wherein grinding the embrittled portion of the food item comprises grinding the embrittled portion of the food item using a rotary grinder.

47. The method of claim 44, wherein a majority of the plurality of particles has a size of less than 750 microns.

48. The method of claim 44, wherein the food item is a piece of fruit or vegetable.

49. The method of claim 44, wherein grinding comprises grinding the embrittled portion of the food item while exposing the embrittled portion of the food item to an inert gas.
